(19) United States
(12) Patent Application Publication
(10) Pub. No.: US 2026/0116004 A1
(43) Pub. Date: Apr. 30, 2026

(54) TRAY ASSEMBLY OF AN ADDITIVE MANUFACTURING SYSTEM

(71) Applicant: Stratasys, Inc., Minnetonka, MN (US)

(72) Inventors: Joel Ong, Minnetonka, MN (US); John Bernard Paton, Minnetonka, MN (US); Elton Cheung, Minnetonka, MN (US); Christopher Prucha, Minnetonka, MN (US)

(21) Appl. No.: 19/163,326

(22) PCT Filed: Mar. 11, 2024
(86) PCT No.: PCT/US24/19434

§ 371 Date: Sep. 8, 2025

Related U.S. Application Data
(60) Provisional application No. 63/451,522, filed on Mar. 10, 2023.

(51) Int. Cl. B29C 64/255; B29C 64/124; B29C 64/245; B29C 64/264; B33Y 30/00

(52) U.S. Cl. CPC B29C 64/255; B29C 64/124; B29C 64/245; B29C 64/264; B33Y 30/00

(57) ABSTRACT

One variation of a tray assembly includes a tray cap that seals over a perimeter of a separation membrane, defines an outer aperture located around a build window of an additive manufacturing system, and defines a reservoir configured to store a resin. The tray assembly also includes a tray base: arranged below the separation membrane opposite the tray cap; including a rim defining an inner aperture inset from the outer aperture and locating a center region of the separation membrane over the build window; cooperating with the separation membrane to form a fluid manifold encircling the rim; and defining a set of orifices extending laterally through the rim and passing fluid between the fluid manifold and an interstitial between the separation membrane and the build window during inflation and deflation of the separation membrane. The tray assembly transiently installs in the additive manufacturing system adjacent the build window.

### CROSS-REFERENCE TO RELATED APPLICATIONS

This Application is a national stage filing of PCT/US2024/019434 under 35 U.S.C. 371, which claims the benefit of U.S. Provisional Patent Application No. 63/451,522, filed on 10 Mar. 2023, each of which is incorporated in its entirety by this reference.

This Application is related to U.S. patent application Ser. No. 17/173,174, filed on 10 Feb. 2021, Ser. No. 16/852,078, filed on 17 Apr. 2020, Ser. No. 16/672,410, filed on 1 Nov. 2019, and Ser. No. 16/672,415, filed on 1 Nov. 2019, each of which is incorporated in its entirety by this reference.

### TECHNICAL FIELD

This invention relates generally to the field of additive manufacturing and more specifically to a new and useful tray assembly of an additive manufacturing system in the field of additive manufacturing.

### BRIEF DESCRIPTION OF THE FIGURES

FIGS. 1A and 1B are schematic representations of a tray assembly;

FIGS. 2A and 2B are schematic representations of one variation of the tray assembly;

FIGS. 3A and 3B are schematic representations of one variation of the tray assembly;

FIG. 4 is a schematic representation of one variation of the tray assembly;

FIG. 5 is a schematic representation of one variation of the tray assembly;

FIG. 6 is a schematic representation of one variation of the tray assembly and an additive manufacturing system; and

FIG. 7 is a flowchart representation of one variation of the tray assembly and the additive manufacturing system.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Tray Assembly

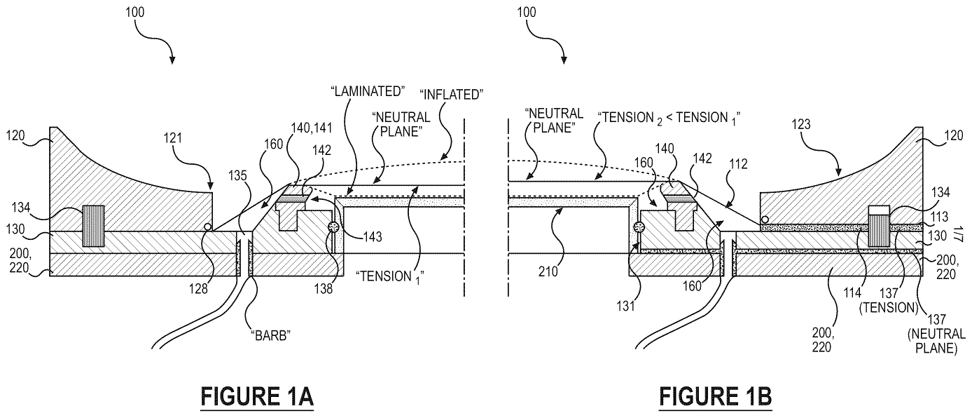

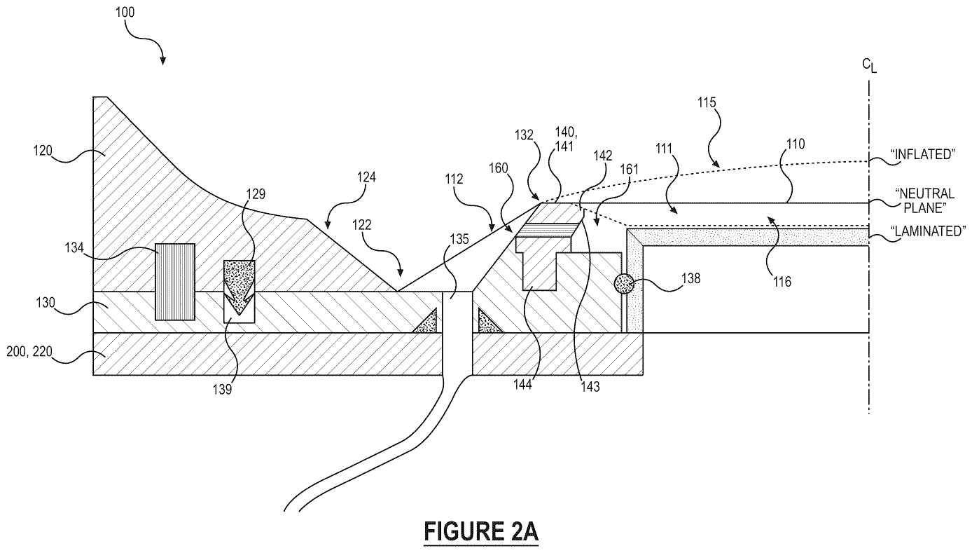

As shown in FIGS. 1A, 1B, 2A, and 2B, a tray assembly 100 includes: a separation membrane 110; a tray cap 120; and a tray base 130.

The separation membrane 110 is configured to: laminate across a build window 210 of an additive manufacturing system 200 prior to irradiation of a resin, loaded into an interstitial volume 115 between the separation membrane 110 and a preceding layer of a part or build substrate, by a projection system in the additive manufacturing system 200; and pass electromagnetic radiation output by the projection system during a build cycle.

The tray cap 120: is arranged over the separation membrane 110; is configured to seal against an upper surface of the separation membrane 110, such as directly or via a separate seal; defines an outer aperture 121 at a first vertical position 122 and configured to locate around the build window 210; and defines a reservoir 123. The reservoir 123 is: arranged about the outer aperture 121; and configured to store a volume of the resin during the build cycle.

The tray base 130: is arranged below the separation membrane 110 opposite the tray cap 120; and includes a rim 140. The rim 140: defines an inner aperture 131 inset from the outer aperture 121 and configured to locate around the build window 210; and defines a rim crest 141 at a second vertical position 132 above the first vertical position 122, circumscribing the inner aperture 131, and configured to locate the separation membrane 110 over the build window 210. The tray base 130 also: cooperates with the separation membrane 110 to form a fluid manifold 160 encircling the rim 140; defines a fluid port 135 fluidly coupled to (e.g., intersecting) the fluid manifold 160; and defines a set of orifices 142. The set of orifices 142: extend laterally through the rim 140 below the rim crest 141; are configured to pass fluid from the fluid manifold 160 into an interstitial region 116 between the separation membrane 110 and the build window 210 during inflation of the separation membrane 110 above the build window 210; and are configured to pass fluid from the interstitial region 116 into the fluid manifold 160 during deflation of the separation membrane 110 and lamination of the separation membrane 110 across the build window 210. The tray base 130 further: cooperates with the tray cap 120 to tension the separation membrane 110 across the inner aperture 131 and against the rim crest 141; and is configured to transiently install in the additive manufacturing system 200 adjacent the build window 210 of the additive manufacturing system 200.

For example, the tray base 130 and the tray cap 120 can be machined from steel or aluminum billet or castings and can be configured to assemble around the separation membrane 110 via a set of threaded fasteners, skewer clamps, or hold-down toggle clamps.

In one variation, the tray assembly 100 includes a kit of separation membranes 110, each separation membrane 110 defining a different thickness and exchangeable between the tray cap 120 and the tray base 130 to yield a range of tension of the separation membrane 110 across the inner aperture 131.

In another variation shown in FIG. 2A, the tray base 130 includes: a retention feature configured to constrain a perimeter 113 of the separation membrane 110 within the tray assembly 100; and a tension channel 139 inset from the retention feature and circumscribing the outer aperture 121. In this variation, the tray assembly 100 further includes a tension element 129 configured to depress into the tension channel 139 to deform the separation membrane 110 into the tension channel 139 and to tension the separation membrane 110 across the inner aperture 131 when the tray cap 120 is installed over the tray base 130. In this variation, the tray assembly 100 can also include a set of tension elements 129, each tension element 129: defining a set of thicknesses; and exchangeable in the tray assembly 100 to yield a range of tensions of the separation membrane 110 across the inner aperture 131.

In another variation, the tray assembly 100 includes a set of rims: defining a set of heights; and exchangeable on the tray base 130 over the inner rim to yield a range of vertical positions of a neutral plane of the separation membrane 110 (i.e., a vertical position of the separation membrane 110 given no pressure gradient across the separation membrane 110) over the build window 210.

In a similar variation, the tray assembly 100 includes a set of shims 137: defining a set of heights; and exchangeable between the tray base 130 and the datum surface adjacent the build window 210 in the additive manufacturing system 200 to yield a range of vertical positions of a neutral plane of the separation membrane 110 over the build window 210.

### 2. Applications

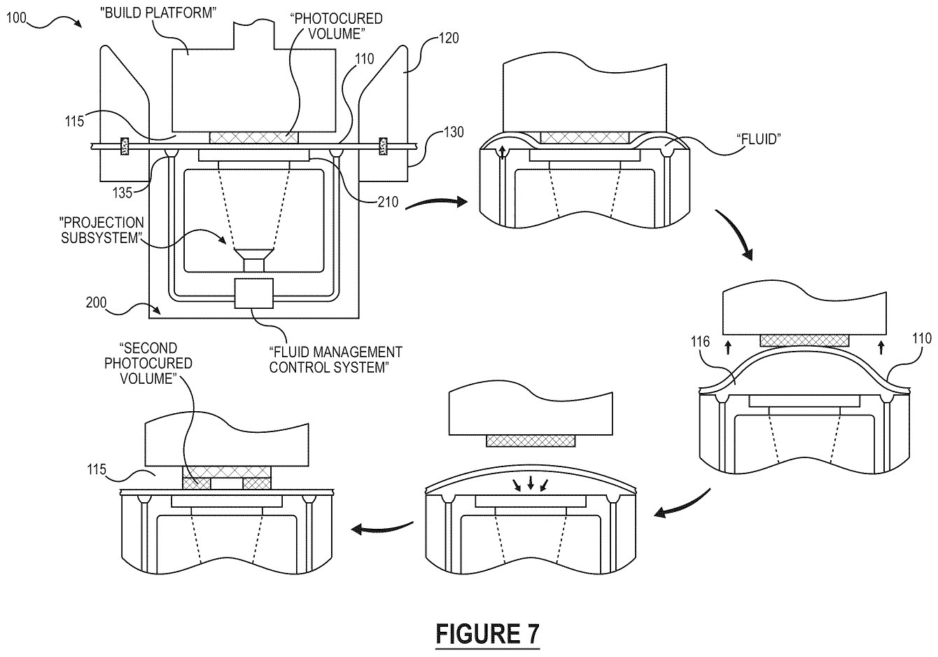

Generally and as shown in FIG. 7, the tray assembly 100 is configured: to transiently locate around a build window 210 within an additive manufacturing system 200; to locate a separation membrane 110 over the build window 210; to store a volume of resin; and to feed resin into an interstitial region between the separation membrane 110 and a preceding layer of a part and/or a build platform of the additive manufacturing system 200—in preparation for selective polymerization of regions of this next layer of the part—during a build. The tray assembly 100 is further configured to communicate fluid (e.g., air, nitrogen, argon) into and out of an interstitial region 116 between the separation membrane 110 and the build window 210: to inflate the separation membrane 110, thereby initiating or expediting separation of the separation membrane 110 from a last layer of the part polymerized against the separation membrane 110; to deflate the separation membrane 110, thereby drawing the separation membrane 110 downward and away from the last layer of the part; and to laminate the separation membrane 110 across the build window 210 in preparation for selective polymerization and fabrication of a next layer of the part between the separation membrane 110 and this last layer of the part.

The tray assembly 100 includes: a tray base 130 defining an inner aperture 131 configured to circumscribe the build window 210 when the tray base 130 is installed in the additive manufacturing system 200; a separation membrane 110 arranged over the tray base 130; and a tray cap 120 that cooperates with the tray base 130 to automatically tension the separation membrane 110 across the inner aperture 131 of the tray base 130 and that seals a periphery of a center region 111 of the separation membrane 110 against the tray base 130. The tray base 130 also includes a rim 140 including a rim crest 141 that intersects a horizontal plane located at a controlled (or “target”) distance offset above the build window 210. Accordingly, the separation membrane 110 occupies a neutral plane offset above the build window 210 when pressure within an interstitial region 116 between the separation membrane 110 and the build window 210 approximates a build chamber pressure above the separation membrane 110. The additive manufacturing system 200 can thus: draw the separation membrane 110 below this horizontal plane and laminate the separation membrane 110 across the build window 210 in preparation for fabricating a next layer of the part by drawing fluid (e.g., air, nitrogen, argon, ethanol, isopropanol, acetone, methanol, water, cyclohexane, mineral oil, a silicone-based oil, glycerol, a polyalphaolefin lubricant, a water-glycol hydraulic fluid) out of this interstitial region 116; and expand the separation membrane 110 above this horizontal plane to separate (or “peel”) the separation membrane 110 from this next layer of the part by injecting fluid into this interstitial region 116.

The tray base 130 can also include: a set of orifices 142 extending laterally through the rim 140 below the rim crest 141; and a fluid port 135 arranged outside of and fluidly coupled to the set of orifices 142. The tray cap 120: seals the separation membrane 110 between the outer seal 128 of the tray cap 120 and the tray base 130; and tensions the separation membrane 110 against the rim crest 141 and across the inner aperture 131. Accordingly, an annular intermediate region 112 of the separation membrane 110 between the inner and outer seals 128 cooperates with an outer section of the rim 140 to form a manifold, such as defining a triangular cross-section formed by the outer section of the rim 140, a manifold base 133 of the tray base 130, and the annular intermediate region 112 of the separation membrane 110. The fluid manifold 160: intersects and fluidly couples the fluid port 135 and the set of orifices 142; and thus cooperates with the fluid port 135 and the set of orifices 142 to communicate fluid (e.g., air, nitrogen, argon ethanol, isopropanol, acetone, methanol, water, cyclohexane, mineral oil, a silicone-based oil, glycerol, a polyalphaolefin lubricant, a water-glycol hydraulic fluid) into and out of the interstitial region 116 to inflate and deflate the separation membrane 110.

### 2.1 Tray Assembly Configuration

Furthermore, the tray assembly 100 can include a kit of separation membranes 110 of different thicknesses and/or elasticities, and an operator may exchange separation membranes 110 between the tray cap 120 and the tray base 130, such as to achieve different tensions of the separation membrane 110 across the inner aperture 131. Additionally or alternatively, the tray assembly 100 can include a kit of tension elements 129 of different geometries (e.g., heights), and an operator may exchange tension elements 129 in the tray cap 120 and/or the tray base 130 to achieve different tensions of the separation membrane 110 across the inner aperture 131. For example, the operator may exchange a separation membrane 110 and/or a tension element 129 in the tray assembly 100 to achieve lower tension in the separation membrane 110 in preparation for printing a part exhibiting lower green strength and/or exhibiting a larger contiguous cross-section; and vice versa.

Additionally or alternatively, the tray assembly 100 can include a kit of rims of different geometries (e.g., heights, profiles). An operator may therefore exchange rims on the tray base 130 to achieve: different offsets between the neutral plane of the separation membrane 110 and the build window 210; and/or different roll-off geometries of the center region 111 of the separation membrane 110 expanding above or retracting below the rim 140.

Additionally or alternatively, the tray assembly 100 can include a kit of shims 137 of different thicknesses. An operator may therefore exchange shims 137 between the tray assembly 100 and the additive manufacturing system 200 to achieve different offsets between the neutral plane of the separation membrane 110 and the build window 210.

In particular, in this and the foregoing implementations, different offset distances between the neutral plane of the separation membrane 110 and the build window 210 may yield: different lamination profiles of the separation membrane 110 against the build window 210 (e.g., different lamination rates or geometries as a function of pressure differential across the separation membrane 110); and/or different delamination profiles of the separation membrane 110 against a last layer of the part (e.g., different delamination forces, force gradients, and rates as a function of pressure differential across the separation membrane 110). For example, the operator may exchange a rim 140 and/or shim 137 in the tray assembly 100 to achieve a smaller vertical offset between the neutral plane of the separation membrane 110 and the separation membrane 110 in preparation for printing a part exhibiting smaller features requiring more accurate lamination of the separation membrane 110 across the build window 210 or fabricated in a material exhibiting less adhesion to the separation membrane 110.

Therefore, the tray assembly 100 can include sets of elements configured to modify separation membrane 110 performance parameters (i.e., separation membrane 110 tension and neutral plane position) in isolate, thereby enabling accurate control and adjustment of membrane separation operation for build of a particular part of a particular geometry and in a particular material.

### 2.2 Tray Assembly Removal

Furthermore, the tray assembly 100 is configured to transiently install in the additive manufacturing system 200 and to locate the separation membrane 110 over the build window 210 during a build and is removable from the additive manufacturing system 200 between builds: a) to enable removal and recycling of excess resin from the additive manufacturing system 200 following a build cycle; b) to enable reloading with a different resin—exhibiting different properties—in preparation for a next build cycle; c) to enable replacement of a damaged separation membrane 110 or replacement with a separation membrane 110 exhibiting different properties (e.g., material, oxygen permeability, elasticity, thickness); d) to enable installation of an alternative separation membrane 110 defining a different thickness that yields a different tension of an operable region of the separation membrane 110 that spans the inner aperture 131; e) to enable replacement of tension features in the tray assembly 100 to yield a different tension across the operable region of the separation membrane 110; f) to enable installation of an alternative rim defining a different thickness that yields a different offset of the natural plane of the separation membrane 110 from the build window 210; and/or g) to enable installation of a different stack of shims 137 between the tray assembly 100 and the additive manufacturing system 200 to yield a different offset of the natural plane of the separation membrane 110 from the build window 210; etc.

### 3. Manufacturing System

Generally, the tray assembly 100 can interface with a manufacturing system, such as described in U.S. patent application Ser. No. 16/672,415 and shown in FIG. 7, to selectively catalyze (or polymerize, or “print”) a sequence of layers of resin to form a three-dimensional volumetric representation of a part model. In particular, the additive manufacturing system 200 is configured to print a three-dimensional part by selectively exposing successive layers of a resin—loaded into an interstitial region 116 between the separation membrane 110 and a build platform and preceding layer of the part—to selectively polymerize individual, successive layers of the part.

The additive manufacturing system 200 can include an assembly of electromechanical components controlled by an imbedded computational device executing computer code (hereinafter the “controller”). More specifically, the additive manufacturing system 200 includes a tray receptacle 220 configured to transiently receive and locate the tray assembly 100 over a build window 210 and below a build palatiform. The additive manufacturing system can include: a projection subsystem arranged under the tray receptacle 220; a build window 210 arranged on the tray receptacle 220; a build platform located over the tray receptacle 220; a build chamber enclosing these elements; and a fluid management control system. The tray assembly 100 is configured to engage the tray receptacle 220, to store a volume of resin (or a “resin reservoir 123”) within the build chamber and proximal the build window 210, and to feed resin into the interstitial volume 115 over the center region 111 of the separation membrane between fabrication of consecutive layers of the part. The additive manufacturing system 200 can thus project electromagnetic radiation into a layer of resin loaded over the build window 210 to selectively polymerize the corresponding layer of the part.

For example, the additive manufacturing system 200 can execute a “bottom-up” digital light process (or “DLP”) to selectively expose and polymerize individual layers of resin loaded over the build window 210. The projection subsystem can therefore face upwardly and project electromagnetic radiation (e.g., ultraviolet, near-ultraviolet, or visible) light through the build window 210 into resin occupying the interstitial volume 115 over the separation membrane 110. Accordingly, the build platform can be arranged vertically over the projection subsystem, build window 210, and the separation membrane 110 and can be configured to advance and retract vertically as the additive manufacturing system 200 selectively irradiates, catalyzes, and photocures resin in the interstitial volume 115 via radiation output by the projection subsystem.

Additionally, the additive manufacturing system 200 can include a build chamber that fully encloses (and seals) the projection subsystem, the build window 210, and the build platform.

### 3.1 Projection Subsystem

The projection subsystem is housed in a base of the additive manufacturing system and can include one or more projectors configured to project electromagnetic radiation in an emissive spectrum, such as the ultraviolet (hereinafter “UV”), visible, or near-infrared (hereinafter “NIR”) spectrum. The projection subsystem can emit electromagnetic radiation in one or more wavelength bands tuned to a chemical composition and physical properties of a resin loaded into the tray assembly 100 and a particular curing process of the resin. For example, the projection subsystem (e.g., a digital UV projector) can be configured to project electromagnetic radiation in an emissive spectrum of 300-nanometer to 450-nanometers that catalyzes local polymerization of the resin.

The projection subsystem: is electrically coupled to the controller; receives digital frames or (“images”) corresponding to full or partial cross-sections of a three-dimensional model of a part before or detail a build; and projects electromagnetic radiation through the build window 210 and the separation membrane 110 to selectively catalyze (or “photocure”) resin—in an interstitial region 116 between the separation membrane 110 the build platform—according to build settings for the part and these frames.

### 3.2 Build Window

The build window 210 is arranged over the tray receptacle 220 and defines the horizontal reference plane over which the separation membrane 110 intermittently laminates to define a lower horizontal surface of the interstitial volume 115 between the separation membrane 110 and the build platform and/or preceding layers of the part. The build window 210 is arranged above the projection subsystem and is aligned with a projection area of the projection subsystem such that a focal plane of the projection subsystem coincides with (e.g., intersects) the resin occupying the interstitial volume 115.

Generally, the build window 210 is substantially transparent (e.g., exhibiting greater than 85% transmittance) to the emissive spectrum of the projection subsystem and thus passes electromagnetic radiation output by the projection subsystem into the resin occupying the interstitial volume 115 above the build window 210. The build window 210 also functions as a rigid support and reference surface for the separation membrane 110 and thus the resin occupying the interstitial volume 115 loaded thereover. The build window 210 can also be sealed over the tray receptacle 220 to support a pressure gradient (e.g., 300 kilopascals) between the build window 210, the tray assembly 100, and the separation membrane 110.

For example, the build window 210 can be manufactured from a pane of transparent, rigid glass, such as amorphous/silicate or crystalline/ceramic glass. In particular, the build window 210 can be both transparent to UV (or other) light output by the projection subsystem and can be substantially rigid, hard, and temperature-stable within an operating temperature of the additive manufacturing system 200 to form a robust, flat reference surface exhibiting minimal deflection and/or deformation during pressure and temperature cycling over the separation membrane 110 during a build, thereby enabling accurate and repeatable lamination of the separation membrane 110 over the build window 210, layer thickness within the part, and flatness of layers within the part.

### 3.3 Build Platform

Generally, the build platform is configured to adhere to a first layer of the part and to suspend the part downward toward the build window 210 during a build. More specifically, the additive manufacturing system 200 can include: a build platform defining a planar surface opposite and substantially parallel to the build window 210; and a linear actuator configured to translate the build platform vertically relative to the build window 210, such as in discrete vertical steps or increments correspond to a target thickness of a layer of the part. As the additive manufacturing system 200 selectively cures resin loaded into the interstitial volume 115 to form successive layers of the part during a build, the additive manufacturing system 200 can trigger the linear actuator to: retract the build platform upwardly by a first distance in order to separate a current layer of the part from the separation membrane 110; and then advance the build platform back toward build window 210 to offset the preceding layer of the part from the separation membrane 110—laminated across the build window 210—by a nominal distance corresponding to a target thickness of the next layer of the part.

In one example, the additive manufacturing system 200 includes a linear actuator—configured to step the build platform over vertical distance increments of 10 microns. Additionally, during actuation of the linear actuator, the controller in the additive manufacturing system 200: can track forces applied by the linear actuator to the build platform (e.g., based on a current draw of the linear actuator or by sampling a force sensor or strain gauge coupled to the build platform); and implement closed-loop controls to maintain forces on the building platform—which correspond to forces between the part suspended therebelow and the separation membrane 110—to less than a maximum force.

### 3.4 Fluid Management Control System

The pressure control system is configured to supply and exhaust fluid (e.g., air, nitrogen, argon, oxygen) to and from the interstitial region 116—via the fluid port 135, the fluid manifold 160, and the set of orifices 142 in the tray assembly 100—to expand and retract the separation membrane 110 during a build cycle.

For example, the pressure control system can include a pressure pump and a vacuum pump selectively actuatable by the controller to expand and retract the separation membrane 110. Alternatively, the pressure control system can include a single pump and a set of valves, and the controller can selectively trigger the set of valves: to fluidly couple an output of the pump to the fluid port 135 to expand the separation membrane 110; and to fluidly couple an input of the pump to the fluid port 135 to retract the separation membrane 110.

### 3.5 Controller

The controller is configured to control and coordinate electromechanical components of the additive manufacturing system 200. Generally, the controller can include an imbedded computer manufacturing system that sends instructions to the projection subsystem to selectively irradiate resin loaded into the interstitial volume 115, to the linear actuator to coordinate vertical positions of the build platform, and to a valve or fluid supply system to selectively expand and retract (or inflate and deflate) the separation membrane 110 over the build window 210.

### 4. Separation Membrane

Generally, the separation membrane 110: is configured to laminate across a build window 210 of a manufacturing system prior to irradiation of a resin loaded into an interstitial volume 115 between the separation membrane 110 and a preceding layer of a part; and is translucent to electromagnetic radiation output by a projection system toward the interstitial volume 115 during a build cycle. More specifically, the separation membrane 110 is configured to: laminate across a build window 210 of an additive manufacturing system 200 prior to irradiation of a resin—loaded into an interstitial volume 115 between the separation membrane 110 and a preceding layer of a part—by a projection system in the additive manufacturing system 200; and pass electromagnetic radiation output by the projection system during a build cycle.

In particular, the separation membrane 110 defines a bottom planar surface: over which the additive manufacturing system 200 locates a resin occupying the interstitial volume 115; and through which the additive manufacturing system 200 selectively exposes and thus polymerizes regions of this resin to form a planar layer of a part.

The separation membrane 110 is also elastic to enable inflation of an operable region of the separation membrane 110 over the build window 210 when the interstitial region 116 is pressurized via the fluid port 135, the fluid manifold 160, and the set of orifices 142. More specifically, deflation of the interstitial region 116 draws the operable region of the separation membrane 110 downward below its neutral plane—defined by the rim crest 141 of the rim 140 of the tray base 130—and laminated the separation membrane 110 across the planar surface of the build window 210 to form a planar build surface below a last layer of a part suspended from the build platform during a build. Similarly, inflation of the interstitial region 116 expands the operable region of the separation membrane 110, delaminates the separation membrane 110 from the build window 210, and “peels” the separation membrane 110 from a last layer of the part irradiated and polymerized over separation membrane 110 during the build.

For example, the separation membrane 110 can include a polytetrafluoroethylene film that is impermeable to oxygen, nitrogen, carbon dioxide, and/or argon. Accordingly, the fluid management control system can selectively inject fluid (e.g., oxygen, nitrogen, carbon dioxide, argon, ethanol, isopropanol, acetone, methanol, water, cyclohexane, mineral oil, a silicone-based oil, glycerol, a polyalphaolefin lubricant, a water-glycol hydraulic fluid) into the fluid port 135 to expand the separation membrane 110 and to peel the separation membrane 110 from a last layer of a workpiece without fluid permeating (or “leaking”) through the separation membrane 110 and onto this last layer of the part. Alternatively, the separation membrane 110 can be selectively permeable to this fluid to aid in separation of the separation membrane 110 from this last layer of the part.

### 5. Tray Base and Tray Cap

As shown in FIGS. 1A and 1B, the tray base 130 and the tray cap 120 are configured to assemble around the separation membrane 110 and to automatically tension the separation membrane 110 across the rim 140 and the inner aperture 131.

In particular, as described above, the tray cap 120: is arranged over the separation membrane 110; is configured to seal against an upper surface of the separation membrane 110, such as directly or via a separate seal; defines an outer aperture 121 at a first vertical position 122 and configured to locate around the build window 210; and defines a reservoir 123. The reservoir 123 is: arranged about the outer aperture 121; and configured to store a volume of the resin during the build cycle.

The tray base 130: is arranged below the separation membrane 110 opposite the tray cap 120; and includes a rim 140. The rim 140: defines an inner aperture 131 inset from the outer aperture 121 and configured to locate around the build window 210; and defines a rim crest 141 at a second vertical position 132 above the first vertical position 122, circumscribing the inner aperture 131, and configured to locate the separation membrane 110 over the build window 210. The tray base 130 also: cooperates with the separation membrane 110 to form a fluid manifold 160 encircling the rim 140; defines a fluid port 135 fluidly coupled to (e.g., intersecting) the fluid manifold 160; and defines a set of orifices 142. The set of orifices 142: extend laterally through the rim 140 below the rim crest 141; are configured to pass fluid from the fluid manifold 160 into an interstitial region 116 between the separation membrane 110 and the build window 210 during inflation of the separation membrane 110 above the build window 210; and are configured to pass fluid from the interstitial region 116 into the fluid manifold 160 during deflation of the separation membrane 110 and lamination of the separation membrane 110 across the build window 210. The tray base 130 further: cooperates with the tray cap 120 to tension the separation membrane 110 across the inner aperture 131 and against the rim crest 141; and is configured to transiently install in the additive manufacturing system 200 adjacent the build window 210 of the additive manufacturing system 200.

For example, the tray base 130 and the tray cap 120 can be machined from steel or aluminum billet or castings and can be configured to assemble around the separation membrane 110 via a set of threaded fasteners, skewer clamps, or hold-down toggle clamps.

### 5.1 Rim

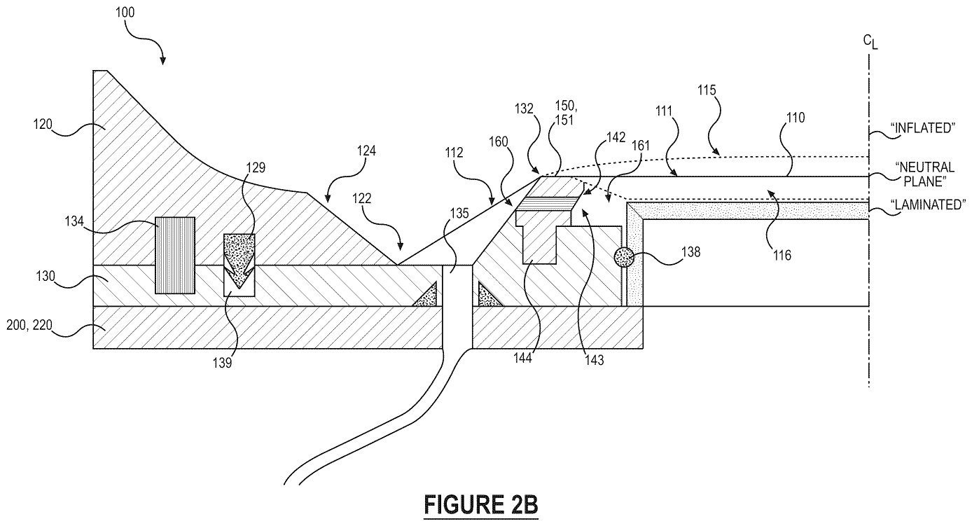

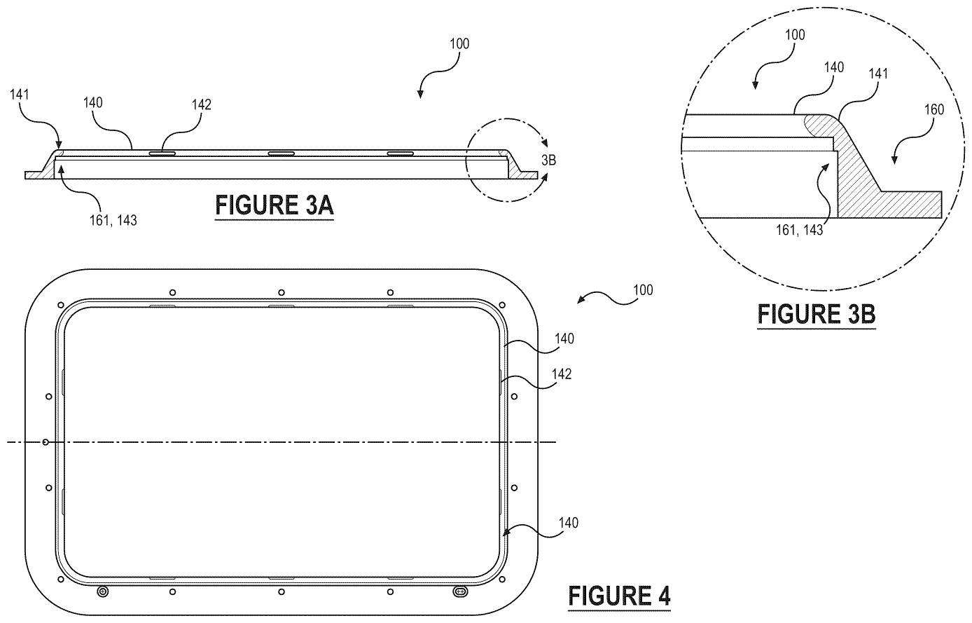

As shown in FIGS. 3A, 3B, 4, and 5, the tray base 130 further defines a rim 140. The rim 140 forms an inner aperture 131 inset from the outer aperture 121 of the tray cap 120 and is configured to circumscribe the build window 210 of the additive manufacturing system 200 when the tray assembly 100 is loaded into the additive manufacturing system 200.

The rim 140 also defines a rim crest 141 (or “peak”): circumscribing the inner aperture 131; and located at a second vertical position 132 offset above the first vertical position 122 at which the tray base 130 and tray cap 120 clamp against and retain an outer region of the separation membrane 110 (i.e., the first vertical position 122 at an interface between the tray base 130, the tray cap 120, and the separation membrane 110). In particular, the rim crest 141 is offset above a lower outer seal surface of the tray base 130 such that the separation membrane 110 deforms out of plane and is tensioned across the rim crest 141 when the tray cap 120 is installed over the separation membrane 110 and clamped or fastened to the tray base 130. The rim crest 141 therefore locates the separation membrane 110 above the build window 210 when the tray assembly 100 is installed in the additive manufacturing system 200.

In particular, the rim 140 extends upwardly above and is inset from the lower outer seal surface of the tray base 130. Thus, when the tray cap 120 is installed onto the tray base 130, the tray cap 120 depresses an intermediate region 112 of the separation membrane 110 downward against the lower outer seal surface of the tray base 130, and the rim 140 raises a center region of the separation membrane 110 above the lower outer seal surface, thereby: tensioning the center region across the rim 140 and the inner aperture 131; and forming a fluid membrane between the intermediate region 112 of the separation membrane 110, the rim 140, and a manifold base 133—inset from the lower outer seal surface—of the tray base 130, as described below.

### 5.2 Tray Cap+Tray Base Outer Seal

Generally, the separation membrane 110 is sealed against a bottom face of the tray cap 120—such as at or near the outer aperture 121 of the tray cap 120—to prevent ingress of resin between the tray cap 120 and the separation membrane 110, such as due to hydraulic pumping of resin into this interstitial volume 115 resulting from repeated inflation and deflation of the separation membrane 110 during a build cycle, which may otherwise reduce clamping tension on the separation membrane 110, increase cleaning difficulty, and result in resin contamination over multiple build cycles. The separation membrane 110 is similarly sealed against an upper face of the tray base 130—such as around and outwardly offset from the rim 140—to prevent egress of fluid (e.g., air, nitrogen, argon) from the adjacent fluid manifold 160, which may otherwise reduce inflation rate and inflation height of the separation membrane 110 and thus reduce a rate or completeness of separation of the separation membrane 110 from a last layer of a workpiece during a build cycle.

In one implementation, the tray base 130 defines a lower outer seal surface (e.g., a flat, planar, horizontal surface) encircling, outset from, and located vertically below the rim 140 of the tray base 130. In this implementation, the tray cap 120 defines the outer aperture 121 outset from the inner aperture 131 defined by the rim 140 of the tray base 130, which is similarly outset from the build window 210 when the tray assembly 100 is installed in the additive manufacturing system 200. The tray cap 120 also includes a downward-facing outer seal 128 (e.g., a flat, ribbed, or o-ring rubber seal, a rigid metallic seal) circumscribing the outer aperture 121. Thus, when the tray cap 120 is assembled onto the tray base 130, the downward-facing outer seal 128 on the tray cap 120 compresses against the separation membrane 110, the separation membrane 110 compresses against the lower outer seal surface of the tray base 130, thereby sealing the separation membrane 110 between the tray cap 120 and the tray base 130.

Additionally or alternatively, the tray base 130 can include a discrete upward-facing outer seal 128 encircling the outer aperture 121 and configured to seal against the bottom face of the separation membrane 110.

In a similar implementation, the tray cap 120 defines an upper outer seal surface (e.g., a flat, planar, horizontal surface) encircling the outer aperture 121. In this implementation, the upper outer seal surface of the tray cap 120 and the lower outer seal surface of the tray base 130 both directly compress the separation membrane 110, and the separation membrane 110 (e.g., a polytetrafluoroethylene film) elastically deforms under this compression to seal against the tray cap 120 and the tray base 130.

For example, the tray cap 120 can include a seal relief groove configured to receive an outer seal 128. When the tray assembly 100 is configured with a thin and/or high-durometer separation membrane 110, the downward-facing outer seal 128 can be inserted into the seal relief groove to seal the tray cap 120 against this thin and/or high-durometer separation membrane 110 that may otherwise not deform sufficiently to seal against the bottom face of the tray cap 120. However, when the tray assembly 100 is configured with a thicker and/or lower-durometer separation membrane 110, the downward-facing outer seal 128 can be removed from the seal relief groove, and the bottom face of the tray cap 120 and the upper face of the tray base 130 can seal directly against thicker and/or lower-durometer separation membrane 110, which may thus deform sufficiently to seal against the bottom face of the tray cap 120 and the upper face of the tray base 130. Additionally or alternatively, the tray base 130 can similarly include a seal relief groove, and an upward-facing outer seal 128 can be similarly installed or removed from this seal relief groove based on thickness and/or durometer characteristics of a separation membrane 110 installed in the tray assembly 100.

Furthermore, the tray cap 120 can define a geometry around the outer aperture 121 configured to limit hydraulic pressure at the tray cap-separation membrane interface during inflation and deflation of the separation membrane 110. In one implementation, the tray cap 120 further defines a transition zone 124: interposed between the reservoir 123 and the outer aperture 121; declined from the reservoir floor toward the outer aperture 121; and thus configured to reduce hydraulic pumping of resin between the separation membrane 110 and the tray cap 120 during inflation and deflation of the separation membrane 110. More specifically, the transition zone 124 of the tray can decline toward the edge of the outer aperture 121 and the separation membrane 110, and the tray cap 120 can seal against the separation membrane 110 up to this edge of the outer aperture 121, thereby: limiting entrapment of resin near this interface during inflation of the separation membrane 110; enabling resin to move up the transition zone 124 of the tray cap 120 during inflation of the separation membrane 110; and limiting hydraulic pressure that may otherwise drive resin into this tray cap-separation membrane interface during inflation of the separation membrane 110. For example, the transition zone 124 of the tray and the separation membrane 110—occupying its neutral plane—can form an included angle between 135° and 170°.

### 5.3 Fluid Manifolds and Fluid Ports

The tray base 130 also cooperates with the separation membrane 110 to form a fluid manifold 160 outside of and encircling the rim 140 and fluidly coupled to the fluid port 135, as shown in FIGS. 1A and 1B.

More specifically, the tray cap 120 retains an annular intermediate region 112 of the separation membrane 110 against the annular lower outer seal surface of the tray base 130. The annular rim of the tray base 130 is inset from the annular lower outer seal surface. An annular manifold region of the separation membrane 110—adjacent and inset from the annular intermediate region 112 of the separation membrane 110—extends from the annular lower outer seal surface up to the annular rim crest 141 of the annular rim. This annular manifold region of the separation membrane 110 this cooperates with the exterior face of the rim 140 to enclose a toroidal volume (hereinafter the “fluid manifold 160”) around the rim 140. The fluid port 135 of the tray base 130 intersects this fluid manifold 160.

In one example, the tray cap 120 defines the outer aperture 121 located at the first vertical position 122 and facing downwardly toward the upper surface of the separation membrane 110. The rim 140 defines the rim crest 141 located at the second vertical position 132 offset above the outer aperture 121 and facing upwardly toward a lower surface of the separation membrane 110. The tray base 130: includes a manifold base 133 interposed between the inner aperture 131 and the outer aperture 121 and located below the rim 140; and defines the fluid port 135 intersecting (i.e., passing through) the manifold base 133. In this example, the separation membrane 110 includes an annular intermediate region 112: tensioned between the outer aperture 121 and the rim crest 141; extending over the manifold base 133; and cooperating with the manifold base 133 and the rim 140 to form the fluid manifold 160.

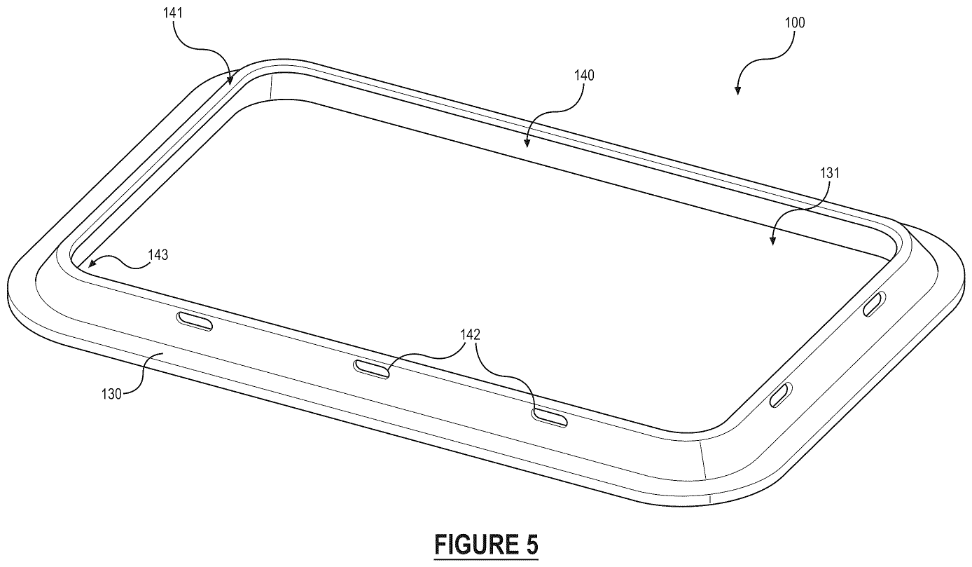

As shown in FIG. 5, the tray base 130 also defines a set of orifices 142: that extend laterally through the rim 140 below the rim crest 141; and that fluidly couple the fluid manifold 160 to the interstitial region 116. In one example, the set of orifices 142 include horizontal elongated oval ports arranged about the rim 140, such as ports 0.060″ tall, 0.50″ wide, located at a pitch distance of 1.50″, and located below the rim crest 141 by a minimum distance of 0.10″. However, the set of orifices 142 can define any other geometry or arrangement.

Generally, the fluid port 135 in the tray base 130 is configured to communicate fluid (e.g., air, nitrogen, oxygen) into and out of the fluid manifold 160. The fluid manifold 160 distributes this fluid between the fluid port 135 and the set of orifices 142 arranged about the rim 140. The set of orifices 142 communicate this fluid between the manifold and the interstitial region 116 below the operable region of the separation membrane 110. Because the set of orifices 142 are fluidly coupled by the fluid manifold 160 and are distributed about the full circumference of the rim 140, the additive manufacturing system 200 can withdraw fluid from about the perimeter of the interstitial region 116, thereby yielding an approximately uniform pressure (e.g., vacuum) gradient from the perimeter of the interstitial region 116 to the center of the interstitial region 116, which may draw the operable region of the separation membrane 110 downward and induce initial contact with the build window 210 proximal the center of the operable region of the separation membrane 110. Further withdrawal of fluid from the interstitial region 116 by the additive manufacturing system 200 may thus induce lamination of the separation membrane 110 across the build window 210—emanating outwardly from this initial contact proximal the center of the operable region of the separation membrane 110—thereby yielding complete, uniform, and repeatable lamination of the operable region of the separation membrane 110 across the build window 210 without trapping fluid between the separation membrane 110 and the build window 210.

With the separation membrane 110 thus laminated across the build window 210, the additive manufacturing system 200 can then selectively expose a volume of resin—interposed between the separation membrane 110 and a last layer of the part suspended thereover—with electromagnetic radiation, thereby selectively polymerizing resin to form a next layer of the part.

Similarly, once the additive manufacturing system 200 selectively exposes this volume of resin to form this current layer of the part, the additive manufacturing system 200 can pump fluid into the interstitial region 116 via the fluid port 135 to expand the operable region of the separation membrane 110 while coordinating upward retraction of the build platform to induce separation of the current layer of the part from the separation membrane 110. More specifically, because the set of orifices 142 are fluidly coupled by the fluid manifold 160 and are distributed about the full circumference of the rim 140, the additive manufacturing system 200 can pump fluid between the separation membrane 110 and the build window 210 about the perimeter of the interstitial region 116, thereby yielding an approximately uniform pressure gradient about the perimeter of the interstitial region 116, which may propagate unform, repeatable delamination—of the separation membrane 110 from the build window 210—that moves radially inwardly from the edge of the build window 210 toward the center of the build window 210 and that may further induce separation of the separation membrane 110 from the current layer of the part.

With the separation membrane 110 fully delaminated from the build window 210 and separated from the current layer of the part, the additive manufacturing system 200 can then withdraw fluid from the interstitial region 116 to re-laminate the operable region of the separation membrane 110 across the build window 210. Resin stored in the tray cap 120—including in the reservoir 123 and over the annular intermediate region 112 of the separation membrane 110—can thus flow into an interstitial region between the separation membrane 110 and the preceding layer of the part.

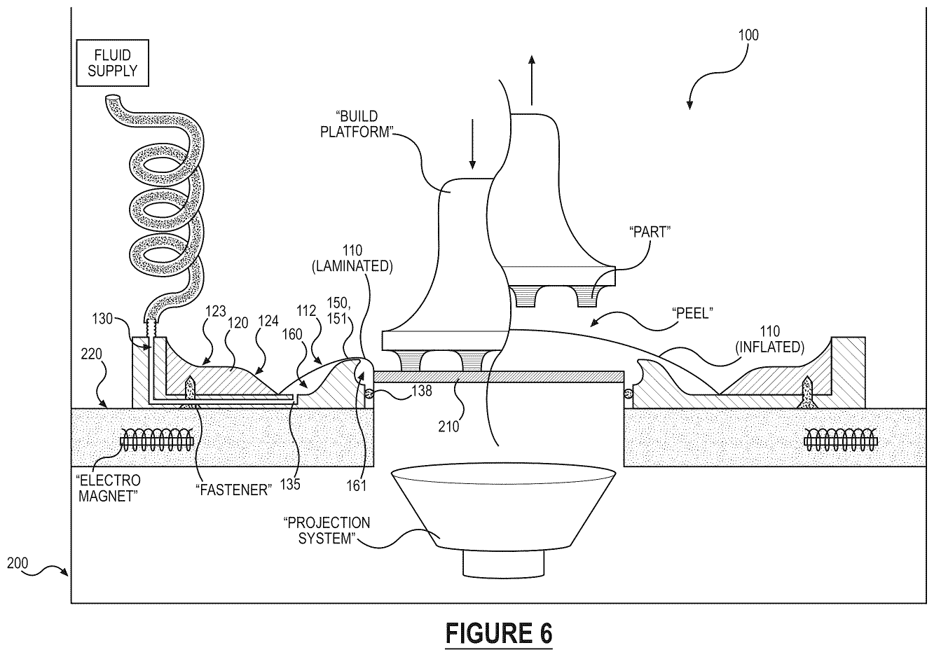

Therefore, the tray base 130 can include a rim 140 that defines a set of orifices 142: configured to pass fluid from the fluid manifold 160 into the interstitial region 116 between the separation membrane 110 and the build window 210 during inflation of a center region 111 of the separation membrane 110 above the build window 210; and configured to pass fluid from the interstitial region 116 into the fluid manifold 160 during deflation of the center region 111 of the separation membrane 110 and lamination of the center region 111 of the separation membrane 110 across the build window 210. Furthermore, the tray cap 120 defines a reservoir 123—such as including a reservoir floor at approximately the second vertical position 132 of the rim crest 141 as shown in FIG. 6—configured to supply resin toward the center region 111 of the separation membrane 110 during a build cycle.

### 5.4 Second Fluid Manifold

Similarly, the rim 140 and the center region 111 of the separation membrane 110 can cooperate to form a second, inner fluid manifold: intersecting the set of orifices 142; and configured to distribute fluid—entering the second fluid manifold 161 via these orifices—around the build window 210 to circumferentially delaminate the separation membrane 110 from the build window 210.

In one implementation shown in FIG. 6, the tray base 130 is configured to transiently install in the additive manufacturing system 200 and thus locate a center region 111 of the separation membrane 110 over the build window 210. The rim 140 defines an undercut section 143: arranged below the rim crest 141; facing the build window 210; intersecting the set of orifices 142; and configured to prevent lamination of the center region 111 of the separation membrane 110 across the set of orifices 142. Furthermore, the separation membrane 110 includes an intermediate annular region interposed between the center region 111 and the rim crest 141. This intermediate annular region of the separation membrane 110 cooperates with the undercut section 143 of the rim 140 to form a second, inner fluid manifold: encircling the build window 210; and configured to distribute fluid—entering the set of orifices 142—about the build window 210 to circumferentially delaminate the center region 111 of the separation membrane 110 from the build window 210.

Generally, the separation membrane 110 may exhibit a first magnitude of deformation to laminate across the build window 210 as fluid is drawn out of this second, inner fluid manifold 160. However, in this implementation, the undercut section 143 is declined away from the separation membrane 110, and this undercut section 143 and the separation membrane 110—when occupying a planar position inline with the rim crest 141—form an obtuse angle. Accordingly, the separation membrane 110 may necessarily exhibit a second magnitude of deformation—much greater than the first magnitude—to laminate across the undercut section 143 of the rim 140 and thus close the set of orifices 142 as fluid is drawn out of this second, inner fluid manifold 160. Therefore, the undercut section 143 of the rim 140 can enable the separation membrane 110 to preferentially laminate fully across the build window 210 before the separation membrane 110 deforms sufficiently to block any orifice in the set of orifices 142 in the rim 140.

### 5.5 Variation: Second/Internal Fluid Manifold Only

In one variation, the tray base 130 includes: a set of blind orifices extending only partially into the interior face of the rim 140 adjacent the build window 210; a fluid manifold 160 located within the rim 140 and intersecting these blind orifices; and a fluid port 135 extending through the tray base 130 to intersect and supply fluid to this fluid manifold 160 to inflate the separation membrane 110 (and vice versa). More specifically, in this variation, the fluid port 135 described above can be arranged within the rim 140 rather than defined by the rim 140, the manifold base 133 on the tray base 130, and the separation membrane 110. Furthermore, in this variation, the tray base 130 can include a breather port intersecting the volume enclosed by the rim 140, the manifold base 133 on the tray base 130, and the separation membrane 110, thereby enabling air to pass into and out of this volume as the separation membrane 110 is inflated and deflated.

### 5.6 Separation Membrane Retention and Tensioning

The tray base 130 and/or the tray cap 120 can further include a set of retention features 134 configured to constrain (or “retain”) the separation membrane 110, such as proximal a perimeter 113 of the separation membrane 110.

In one implementation, the separation membrane 110 includes an array of perforations 114 arranged proximal a periphery (or perimeter 113) of the separation membrane 110. In this example, the set of retention features 134 include a set of posts extending upwardly from the tray base 130 and configured to: insert into the array of perforations 114 in the separation membrane 110; retain the separation membrane 110 via the array of perforations 114; and horizontally constrain the perimeter 113 of the separation membrane 110, such as when the tray cap 120 is depressed onto the separation membrane 110 to tension the separation membrane 110 across the rim 140 and to complete assembly of the tray assembly 100.

In a similar implementation, the tray base 130 (or the tray cap 120) includes a set of standoffs (e.g., “posts”) adjacent and inset from its perimeter; and tray cap 120 (or the tray base 130) includes a corresponding set of standoff receivers. In this implementation, the separation membrane 110 includes a set of bores arranged in a similar pattern and configured to locate over the set of standoffs. The standoffs thus retain and locate the perimeter 113 of the separation membrane 110 in the tray assembly 100. When the tray cap 120 is assembled onto the separation membrane 110 and the tray base 130, the bottom face of the tray cap 120 draws an outer region of the separation membrane 110 downward and below the rim 140 of the tray base 130, thereby stretching the separation membrane 110 between the set of standoffs and tensioning the separation membrane 110 across the rim 140.

When the tray cap 120 is installed over the tray base 130, the tray cap 120 can thus: draw the separation membrane 110 downwardly along these standoffs; compress and seal the separation membrane 110 against the lower outer seal surface of the tray base 130; and concurrently stretch and tension the separation membrane 110 across the rim 140 of the tray base 130.

Alternatively, in the foregoing implementations, the set of standoffs can extend downwardly from the tray cap 120 and can be configured to insert into corresponding standoff receivers located in the tray base 130.

In another implementation, the tray cap 120 includes a set of clamps configured to clamp and retain the periphery of the separation membrane 110 against the bottom face of the tray cap 120. For example, the set of clamps can include: a set of hold-down toggle clamps arranged in each corner of the tray cap 120; or an annular clamp configured to fasten (e.g., via a set of threaded fasteners) the bottom face of the tray cap 120 to clamp and retain the separation membrane 110. In this implementation, the tray cap 120 and the separation membrane 110 can then be installed on and fastened to the tray base 130 (e.g., by a set of threaded fasteners), thereby tensioning the separation membrane 110 across the rim 140 and completing assembly to the tray assembly 100.

However, the tray base 130 and the tray cap 120 can include any other elements or features configured to retain the periphery of the separation membrane 110 as the tray assembly 100 is assembled and the separation membrane 110 is tensioned across the rim 140.

### 6. Separation Membrane Tension Adjustment

Generally, tension in the separation membrane 110 may be proportional to a distance between: the first vertical position 122 of the bottom face of the tray cap 120; and a second vertical position 132 of the rim crest 141. Therefore, the tray assembly 100 can accommodate an increase in distance between these surfaces in order to increase tension in the separation membrane 110, and vice versa.

For example, the tray assembly 100 can accommodate an increase in this distance—and thus increase in separation membrane 110 tension: when a thicker separation membrane 110 is installed in the tray assembly 100; when a more elastic separation membrane 110 is installed in the tray assembly 100; when a separation membrane 110 with less in-plane stiffness (e.g., a separation membrane 110 exhibiting greater propensity for wrinkling) is installed in the tray assembly 100; and/or when a workpiece with thicker or higher-green-strength features is fabricated in the additive manufacturing system 200 to promote faster separation from layers of the part without part damage; and vice versa.

### 6.1 Separation Membrane Tension Adjustment: Shims

In one implementation shown in FIGS. 1A and 1B, the tray assembly 100 further includes a kit of flat membrane shims 137, wherein each membrane shim 137: defines a perimeter profile and perimeter perforations analogous (e.g., similar, identical) to the separation membrane 110; and defines an inner shim 137 aperture adjacent and outset from the rim 140 and the fluid port 135 of the tray base 130. In this implementation, to control and set tension of the separation membrane 110 across the rim 140 of the tray assembly 100, an operator may: locate one or a stack of membrane shims 137 on the tray base 130; locate the separation membrane 110 over the stack of membrane shims 137; and then install the tray cap 120 over the separation membrane 110.

In particular, the stack of membrane shims 137 sets a vertical offset distance between the perimeter 113 of the separation membrane 110 and the region of the separation membrane 110 spanning the rim 140 when the tray assembly 100 is assembled. The tension across the operable region of the separation membrane 110—spanning the rim 140 and the inner aperture 131 of the tray assembly 100—is proportional to this vertical offset distance. Therefore, in this implementation, the operator may install a thicker stack of shims 137 between the separation membrane 110 and the tray base 130 to decrease this tension—and vice versa—without affecting the vertical offset distance between the build window 210 and the neutral plane of the separation membrane 110 when the tray assembly 100 is installed in the additive manufacturing system 200.

### 6.2 Separation Membrane Tension Adjustment: Tension Element

In another implementation shown in FIGS. 2A and 2B, the tray base 130 includes: a set of retention features 134 (e.g., a set of posts or standoffs) configured to constrain the separation membrane 110, proximal a perimeter 113 of the separation membrane 110, to the tray base 130; and a tension channel 139 interposed between the set of retention features 134 and the rim 140. In this implementation, the tray cap 120 includes a tension element 129: extending downwardly; and configured to depress the separation membrane 110 into the tension channel 139 during assembly of the tray cap 120 onto the tray base 130 to tension the separation membrane 110 across the rim 140. For example, the tension element 129 can include a continuous, annular shoulder: extending downwardly from the bottom face of the tray cap 120; configured to insert into the tension channel 139; and to draw the separation membrane 110 into the tension channel 139 during assembly of the tray assembly 100.

Therefore, in this implementation, the tray base 130 (or the tray cap 120) can include a tension channel 139 encircling and outset from the lower outer seal surface. In this implementation, the tray assembly 100 can also include a kit of annular tension elements 129 of different heights (or thicknesses), each configured to: install in the tension channel 139; depress the separation membrane 110 into the tension channel 139 in the tray base 130 when the tray cap 120 is assembled over the tray base 130; and thus tension the separation membrane 110 within the tray assembly 100. Accordingly, an operator may selectively exchange an annular tension element 129 in the tray assembly 100 in order to achieve a different tension across the separation membrane 110 when the tray assembly 100 is assembled.

In particular, an annular tension element 129 sets a distance that the separation membrane 110 is depressed into the tension channel 139, as shown in FIGS. 2A and 2B. Tension across the operable region of the separation membrane 110 may be proportional to the distance that the separation membrane 110 is depressed into the tension channel 139 by an annular tension element 129 and may therefore be a function of a height of the annular tension element 129. Therefore, in this implementation, the operator may install a thicker annular tension element 129 between the separation membrane 110 and the tray cap 120 to increase tension on the separation membrane 110—and vice versa—without affecting the vertical offset distance between the build window 210 and the neutral plane of the separation membrane 110 when the tray assembly 100 is installed in the additive manufacturing system 200.

For example, the tray assembly 100 can include a first tension element 129: configured to transiently install in the tension channel 139; defining a first height; and configured to depress the separation membrane 110 into the tension channel 139 by a first distance to tension the separation membrane 110 to a first tension across the rim 140. In this example, the tray assembly 100 can also include a second tension element 129: configured to transiently install in the tension channel 139 in replacement of the tension element 129; defining a second height greater than the first height; and configured to depress the separation membrane 110 into the tension channel 139 by a second distance to tension the separation membrane 110 to a second tension—greater than the first tension—across the rim 140.

### 6.3 Separation Membrane Tension Adjustment: Separation Membrane

Additionally or alternatively, the tray assembly 100 can include a kit of separation membranes 110 of different thicknesses and/or elasticities. Accordingly, the operator may exchange separation membranes 110 in the tray assembly 100 to achieve different tensions across the rim 140 of the tray assembly 100.

### 7. Fluid Coupling to Fluid Port

In one implementation, the tray assembly 100 includes a hose bib coupled to the fluid port 135 in the tray base 130. A pressure control system arranged in the tray receptacle 220 of the additive manufacturing system 200 includes a flexible hose coupled to the pressure control system and extending into the build chamber. In this implementation, the operator may connect the flexible hose to the hose bib on the tray assembly 100 before loading the tray assembly 100 into the build chamber, thereby fluidly coupling the interstitial region 116 to the pressure control system via the manifold and the set of orifices 142 in the rim 140.

In another implementation shown in FIGS. 1A and 1B, the tray receptacle 220 of the additive manufacturing system 200 includes a barb: that extends upwardly from tray receptacle 220 of manufacturing system adjacent the build window 210; and configured to insert into and to seal against the fluid port 135 in the tray assembly 100 when the tray assembly 100 is loaded into the additive manufacturing system 200. In this implementation, the pressure control system is arranged in the tray receptacle 220 of the additive manufacturing system 200 and is coupled to the barb, such as via a rigid or flexible fluid line. In this implementation, when the operator loads the tray assembly 100 into the build chamber, the barb can insert into and seal against the fluid port 135 in the tray assembly 100 to fluidly couple the pressure control system to the interstitial region 116 via the manifold and the set of orifices 142 in the rim 140.

In yet another implementation, the additive manufacturing system 200 includes a second fluid port: arranged in the tray receptacle 220 of the additive manufacturing system 200 adjacent the build window 210; and configured to align with the fluid port 135 in the tray assembly 100 when the tray assembly 100 is loaded into the build chamber. A seal arranged in the tray receptacle 220 of the additive manufacturing system 200 and located around the second fluid port seals the fluid port 135 of the tray base 130 to the second fluid port of the additive manufacturing system 200 when the tray assembly 100 is loaded into and clamped against the build chamber. (Conversely, the seal can be arranged around the fluid port 135 in the tray base 130 and can seal the fluid port 135 to the second fluid port when the tray assembly 100 is loaded into the build chamber.) In another implementation, the tray base 130 further includes a fluid channel 136: fluidly coupled to the fluid port 135; extending horizontally (or laterally) from the fluid port 135 to an outer face of the tray base 130; and configured to transiently couple to a flexible fluid supply line arranged in the additive manufacturing system 200 above the build window 210. Thus, in this implementation, rather than the additive manufacturing system 200 supplying fluid to the tray assembly 100 via a second fluid port or other fluid supply near the build window 210, the additive manufacturing system 200 can include a flexible supply line remote from the build window 210; and the tray assembly 100 can be configured to transiently (i.e., removably) couple to the flexible supply line to supply fluid to the fluid channel 136, the fluid port 135, the fluid manifold 160, and the set of orifices 142 to inflate the separation membrane 110, and vice versa.

### 8. Tray Assembly Retention

In one implementation, the tray base 130 includes a set of magnetic elements (e.g., permanent magnets, ferrous inserts) configured to transiently: couple to corresponding magnetic elements (e.g., ferrous inserts, permanent or electro-magnets) adjacent the build window 210 in the additive manufacturing system 200; and thus retain the tray assembly 100 within the additive manufacturing system 200.

In another implementation, the tray cap 120 includes a set of clamp landing pads proximal a perimeter of the tray assembly 100, the additive manufacturing system 200 includes a set of mechanical clamps configured to transiently engage these clamp landing pads and to retain the tray assembly 100 within the additive manufacturing system 200.

In another implementation, the additive manufacturing system 200 includes a perforated surface: arranged about the build window 210; coupled to a vacuum supply (e.g., toolpath form a “vacuum table”); and configured to retain the bottom face of the tray base 130.

However, the tray assembly 100 can interface with the additive manufacturing system 200 in any other way and can be transiently retained in the additive manufacturing system 200 in any other way.

### 9. Separation Membrane: Inflation+Deflation+Neutral Plane

As described above, the tray base 130 is configured to transiently install in the additive manufacturing system 200, thereby locating a center region 111 of the separation membrane 110 over the build window 210 in the additive manufacturing system 200. Accordingly, the separation membrane 110 is operable in: a nominal position with the center region 111 of the separation membrane 110 approximating a planar surface—intersecting a neutral plane—at the second vertical position 132 and offset above the build window 210; a retracted position with the center region 111 of the separation membrane 110 laminated across the build window 210 and with a second region of the separation membrane 110 tensioned out of plane between the build window 210 and the rim crest 141; and an expanded position with the center region 111 of the separation membrane 110 inflated out of plane above the build window 210 to peel the center region 111 of the separation membrane 110 from the build window 210.

In particular, in the presence of equal pressures on each side of the center region 111 of the separation membrane 110, the center region 111 of the separation membrane 110 approximates a planar surface across the rim 140. However, when the additive manufacturing system 200 pumps fluid into the fluid part, the fluid manifold 160, and the set of orifices 142, pressure behind the center region 111 of the separation membrane 110 increases, and the separation membrane 110 expands (or “balloons”) outwardly to form a convex surface. As a build platform and part are retracted above the build window 210 and separation membrane 110, the expanded, convex separation membrane 110 peels away from and releases from a last polymerized layer of the part. When the additive manufacturing system 200 then pumps fluid out the fluid port, the fluid manifold 160, and the set of orifices 142, pressure behind the center region 111 of the separation membrane 110 decreases, and the separation membrane 110 retracts inwardly to form a concave surface and then laminates against the build window 210 to approximate a geometry (e.g., a plane) of the build window 210. In particular, lamination of the separation membrane 110 against the build window 210 occurs circumferentially and radiates outwardly from the center of the separation membrane 110, which makes first contact with the build window 210.

### 9.1 Neutral Plane Control

Generally, the tray assembly 100 can accommodate a range of neutral plane positions of the separation membrane 110. For example, increasing the distance between the neutral plane of the separation membrane 110 and the build window 210 may yield: a decrease in a minimum positive pressure needed to expand the separation membrane 110; more rapid separation of the separation membrane 110 from a last layer of the part; greater force applied to the part during separation of the separation membrane 110; an increase in a minimum negative pressure (i.e., vacuum) necessary to laminate the separation membrane 110 across the build window 210; and/or longer separation membrane-build window lamination times. Conversely, decreasing the distance between the neutral plane of the separation membrane 110 and the build window 210 may yield: an increase in a minimum positive pressure needed to expand the separation membrane 110; slower separation of the separation membrane 110 from a last layer of the part; reduced force applied to the part during separation of the separation membrane 110; a decrease in a minimum negative pressure necessary to laminate the separation membrane 110 across the build window 210; and/or shorter separation membrane-build window lamination times.

Additionally or alternatively, a separation membrane 110 exhibiting greater elasticity may necessitate a greater offset distance between its neutral plane and the build window 210 in order to achieve consistent circumferential lamination of the separation membrane 110 across the build window 210. Conversely, because a more rigid separation membrane 110 may exhibit less deformation under similar pressure differentials, a more rigid separation membrane 110 may necessitate a shorter offset distance between its neutral plane and the build window 210 in order to enable the separation membrane 110 to fully laminate across the build window 210 without plastic deformation and/or without exceeding a negative pressure (i.e., vacuum) limit of the additive manufacturing system 200.

### 9.2 Fluid Boundary+Neutral Plane Adjustment via Shims

In one implementation shown in FIGS. 1A and 1B, the tray assembly 100 (or the additive manufacturing system 200) includes an inner aperture 131 seal configured to seal the inner aperture 131 of the tray assembly 100—below the separation membrane 110—against a perimeter of the build window 210. In one example, the build window 210 defines a seal groove. The inner aperture 131 seal—arranged in the seal groove about the build window 210—seals against the inner aperture 131 of the tray base 130 when the tray assembly 100 is loaded into the additive manufacturing system 200. Accordingly, the fluid port 135, the interior face of the separation membrane 110, the set of orifices 142 in the rim 140 of the tray base 130, the inner aperture 131 of the tray base 130, the build window 210, and the seal form a pressure envelope. The additive manufacturing system 200 can thus selectively pressurize and depressurize this pressure envelop—via the fluid port 135—to inflate and deflate the separation membrane 110 over the build window 210.

In a similar implementation, the build window 210 defines a column extending upwardly from the tray receptacle 220 of the additive manufacturing system 200. In this implementation, the inner aperture 131 seal can be arranged on the inner aperture 131 of the tray assembly 100 and can seal the inner aperture 131 of the tray assembly 100 against vertical sides of the column of the build window 210 over a range of vertical positions, thereby accommodating a range of vertical offsets between the build window 210 and the neutral plane of the separation membrane 110. For example, an operator may install shims 137 of various thicknesses between the tray receptacle 220 of the additive manufacturing system 200 and the tray assembly 100 to set vertical offsets between the build window 210 and the neutral plane of the separation membrane 110 over multiple build cycles to fabricate various parts in various materials. For each of these configurations, the seal on the inner aperture 131 of the tray assembly 100 can seal against the vertical sides of the column of the build window 210.

In this implementation and the implementations described above in which the tray receptacle 220 of the additive manufacturing system 200 includes a barb configured to insert into the fluid port 135 of the tray assembly 100, the barb and the fluid port 135 can also be configured to seal over a range of vertical positions (i.e., insertion depths of the barb into the fluid port 135) to similarly support a range of shim 137 thicknesses and thus a range of vertical offsets between the build window 210 and the neutral plane of the separation membrane 110, as shown in FIGS. 1A and 1B.

For example and as described above, the separation membrane 110 can cooperate with the rim 140 to form a second fluid manifold 161: encircling the build window 210; and configured to distribute fluid—entering the set of orifices 142—about the build window 210 to circumferentially delaminate the center region 111 of the separation membrane 110 from the build window 210, and vice versa. In this example, the tray base 130 can further include a build window seal 138 configured to: seal against a support structure (e.g., a column) supporting the build window 210 within the additive manufacturing system 200; and prevent egress of fluid from the second fluid manifold 161 past the tray base 130 and the build window 210. Thus, in this example, the tray base 130, the separation membrane 110, and the build window seal 138 can cooperate with the support structure and the build window 210 of the additive manufacturing system 200 to form a closed volume configured to receive fluid via the fluid port 135 to expand the separation membrane 110, and vice versa. Furthermore, the build window seal 138 can be configured to seal against the build window 210 support structure over a range of heights, and the tray assembly 100 can include a set of shims 137. Accordingly, an operator may selectively insert shims 137 between the tray assembly 100 and the additive manufacturing system 200 in order to increase a distance between the build window 210 and the neutral plane of the separation membrane 110.

### 9.3 Fluid Boundary+Neutral Plane Adjustment via Tray Base Exchange

In another implementation, the tray base 130 includes a seal around the inner aperture 131 and configured to seal the tray assembly 100 to a tray receptacle 220 around the build window 210 within the additive manufacturing system 200. Accordingly, the separation membrane 110, the build window 210, the inner aperture 131 of the tray base 130, and the tray receptacle 220 of the additive manufacturing system 200 inside of the seal form a pressure envelope. The additive manufacturing system 200 can thus selectively pressurize and depressurize this pressure envelop—via the fluid port 135—to inflate and deflate the separation membrane 110 over the build window 210.

In this implementation, the tray assembly 100 can include a set of tray bases 130, each defining a different rim height. Accordingly, an operator may control and vary vertical offsets between the build window 210 and the neutral plane of the separation membrane 110 by exchanging these tray bases 130.

### 9.4 Fluid Boundary+Neutral Plane Adjustment via Rim Exchange

Alternatively, in the foregoing implementations, the tray assembly 100 can include a set of rims of different heights. The tray base 130 can include a rim receptacle 144 (or “channel”) circumscribing the inner aperture 131 and configured to transiently receive a rim from this set of rims.

For example, the tray assembly 100 can include a kit of annular rims of various heights. In this example, the tray base 130 can define a rim receptacle 144 arranged about the inner aperture 131 and configured to receive an annular rim in the kit of annular rims. Accordingly, the operator may exchange an annular rim in the rim receptacle 144 of the tray base 130 to vary vertical positions of the rim crest 141 on the tray base 130 and thus control offsets between the build window 210 and the neutral plane of the separation membrane 110 when the tray assembly 100 is installed in the additive manufacturing system 200.

Therefore, the tray base 130 can include a rim receptacle 144 inset from the outer aperture 121 and configured to locate around the build window 210. The tray assembly 100 can also include a first rim: configured to transiently seat in the rim receptacle 144; and defining a first rim crest 141 configured to offset the separation membrane 110 above the build window 210 by a first offset distance. The tray assembly 100 can also include a second rim 150: configured to transiently seat in the rim receptacle 144 in replacement of the first rim; defining a second inner aperture 131 inset from the outer aperture 121 and configured to locate around the build window 210; and defining a second rim crest 151 at a third vertical position above the first vertical position 122, circumscribing the inner aperture 131, and configured to offset the separation membrane 110 above the build window 210 by a second offset distance greater than the first offset distance.

In this implementation, the rim 140 can be retained in the rim receptacle 144 via tension in the separation membrane. Alternatively, the rim 140 can be retained in the rim receptacle 144: via a set of threaded fasteners; or via corresponding magnetic elements arranged in the rim 140 and the rim receptable 144; etc.

### 9.5 Fluid Boundary+Neutral Plane Adjustment via Shimmed Rim

In a similar implementation, the tray base 130 includes a rim receptacle 144 inset from the outer aperture 121 and configured to locate around the build window 210. The tray assembly 100 includes a rim 140: configured to transiently seat in the rim receptacle 144; and defining the rim crest 141 configured to offset the separation membrane 110 above the build window 210 by a first offset distance. In this implementation, the tray assembly 100 further includes a shim 137 configured to: insert between the rim receptacle 144 and the rim 140; and raise the rim crest 141 to a third vertical position above the first vertical position 122 to offset the separation membrane 110 above the build window 210 by a second offset distance greater than the first offset distance. In this implementation, the tray assembly 100 can further include additional shims 137 of the same or different thickness.

Therefore, an operator may selectively insert shims 137 between the rim 140 and the rim receptacle 144 in order to modify an offset distance between the neutral plane of the separation membrane 110 and the build window 210.

### 9.6 Fluid Boundary+Neutral Plane Adjustment via Seal Exchange

Alternatively, in the foregoing implementation, the tray assembly 100 can include a kit of seals, each seal: defining a flat, rigid (e.g., steel) insert configured to mate with (i.e., contact) the tray receptacle 220 of the additive manufacturing system 200 and the bottom face of the tray assembly 100 to vertically locate the tray assembly 100—repeatably and accurately—within the additive manufacturing system 200; and including a set of seal elements extending from the upper and lower faces of the rigid insert and thus configured to seal the tray receptacle 220 and the tray assembly 100.

In this implementation, the operator may therefore exchange these seals in the additive manufacturing system 200 to control and vary vertical offsets between the build window 210 and the neutral plane of the separation membrane 110.

### 10. Window Clamp With Integral Rim

In one variation, a system includes: a tray assembly 100; and a window clamp.

The tray assembly 100 includes: a separation membrane 110; a tray cap 120; and a tray base 130.

The tray cap 120: is arranged over the separation membrane 110; is configured to seal against an upper surface of the separation membrane 110; defines an outer aperture 121 configured to locate around a build window 210 of the additive manufacturing system 200; and defines a reservoir 123 arranged about the outer aperture 121 and configured to cooperate with the separation membrane 110 to store resin.

The tray base 130: is arranged below the separation membrane 110 opposite the tray cap 120; and cooperates with the tray cap 120 to tension the separation membrane 110 across the outer aperture 121.

The window clamp: is arranged about the build window 210 in the additive manufacturing system 200; and includes a rim 140. The rim 140: defines an inner aperture 131 inset from the outer aperture 121 and configured to locate around the build window 210; and defines a rim crest 141 circumscribing the inner aperture 131 and configured to locate the separation membrane 110 above the build window 210. The window clamp also cooperates with the separation membrane 110 to form a fluid manifold 160: extending between the outer aperture 121 and the rim 140; and arranged over a fluid port 135 within the additive manufacturing system 200. The window clamp further defines a set of orifices 142: extending laterally through the rim 140 below the rim crest 141; configured to pass fluid from the fluid manifold 160 into an interstitial region 116 between the separation membrane 110 and the build window 210 during inflation of the separation membrane 110 above the build window 210; and configured to pass fluid from the interstitial region 116 into the fluid manifold 160 during deflation of the separation membrane 110 and lamination of the separation membrane 110 across the build window 210.

More specifically, in this variation, the rim 140 is integral with the tray receptacle 220 of the additive manufacturing system 200 and forms (or is integral with) a window clamp that rigidly retains the build window 210 (or is otherwise rigidly located around the build window 210). In this variation, the tray assembly 100: defines an outer aperture 121 configured to locate around the rim 140; retains the separation membrane 110 across the aperture; and is configured to tension the separation membrane 110 across the rim 140 when the tray assembly 100 is seated on the tray receptacle 220 of the additive manufacturing system 200 around the window clamp and rim. In this variation, the tray receptacle 220 of the additive manufacturing system 200 defines a fluid port 135: interposed between the rim 140 and the outer aperture 121 of the tray assembly 100; and configured to communicate fluid into the fluid manifold 160 defined between the rim 140, the separation membrane 110, and the outer aperture 121 of the tray assembly 100, as described above.

Furthermore, in this variation, the rim 140 can define a set of orifices 142 configured to communicate fluid into and out of the interstitial region 116 between the separation membrane 110 and the build window 210 to inflate and deflate the separation membrane 110. The tray assembly 100 can also be retained in the additive manufacturing system 200 via magnetic, mechanical, or other retention methods that draw the tray assembly 100 downwardly onto the tray receptacle 220 of the additive manufacturing system 200, thereby driving the rim 140 into the separation membrane 110 and tensioning the separation membrane 110 across the rim 140. Furthermore, in this variation, system can include a set of window clamps, each defining a different rim height or geometry and configured to transiently install in the additive manufacturing system 200 around the build window 210 to yield different offset distances between the build window 210 and the neutral plane of the separation membrane 110.

Additionally or alternatively, the system can include a set of shims 137 configured to insert between the tray assembly 100 and the additive manufacturing system 200 in order to selectively raise the tray assembly 100 within the additive manufacturing system 200, thereby reducing tension on the separation membrane 110 when the tray assembly 100 is installed in the additive manufacturing system 200. Additionally or alternatively, the system can include a set of tray bases 130, each defining a different distance between its bottom and top faces and configured to selectively assemble with the tray cap 120 and the separation membrane 110 to yield different tensions across the separation membrane 110 when the tray assembly 100 is installed in the additive manufacturing system 200.

As a person skilled in the art will recognize from the previous detailed description and from the figures and claims, modifications and changes can be made to the embodiments of the invention without departing from the scope of this invention as defined in the following claims.

I claim:

1. A tray assembly comprising:
a separation membrane configured to:
laminate across a build window of an additive manufacturing system prior to irradiation of a resin, loaded into an interstice between the separation membrane and a preceding layer of a workpiece, by a projection system in the additive manufacturing system; and
pass electromagnetic radiation output by the projection system during a build cycle;
a tray cap:
arranged over the separation membrane;
configured to seal against an upper surface of the separation membrane;
defining an outer aperture at a first vertical position and configured to locate around the build window; and
defining a reservoir;
arranged about the outer aperture; and
configured to store a volume of the resin during the build cycle; and
a tray base:
arranged below the separation membrane opposite the tray cap;
comprising a rim:
defining an inner aperture inset from the outer aperture and configured to locate around the build window; and
defining a rim crest at a second vertical position above the first vertical position, circumscribing the inner aperture, and configured to locate the separation membrane over the build window;
cooperating with the separation membrane to form a fluid manifold encircling the rim;
defining a fluid port fluidly coupled to the fluid manifold;
defining a set of orifices:
extending laterally through the rim below the rim crest;
configured to pass fluid from the fluid manifold into an interstitial volume between the separation membrane and the build window during inflation of the separation membrane above the build window; and
configured to pass fluid from the interstitial volume into the fluid manifold during deflation of the separation membrane and lamination of the separation membrane across the build window;
cooperating with the tray cap to tension the separation membrane across the inner aperture and against the rim crest; and
configured to transiently install in the additive manufacturing system adjacent the build window.

2. The tray assembly of claim 1:
wherein the tray base is configured to transiently install in the additive manufacturing system to locate a center region of the separation membrane over the build window; and
wherein the separation membrane is operable in:
a nominal position with the center region of the separation membrane approximating a planar surface at the second vertical position and offset above the build window;
a retracted position with the center region of the separation membrane laminated across the build window and with a second region of the separation membrane tensioned out of plane between the build window and the rim crest; and
an expanded position with the center region of the separation membrane inflated out of plane above the build window to peel the center region of the separation membrane from the build window.

3. The tray assembly of claim 1:
wherein the tray cap:
further comprises an outer seal arranged about the outer aperture and configured to seal against the upper surface of the separation membrane; and
defines the outer aperture located at the first vertical position and facing downwardly toward the upper surface of the separation membrane;
wherein the rim defines the rim crest located at the second vertical position and facing upwardly toward a lower surface of the separation membrane;
wherein the tray base:
comprises a manifold base interposed between the inner aperture and the outer aperture and located below the rim; and
defines the fluid port intersecting the manifold base; and
wherein the separation membrane comprises an annular intermediate region:
tensioned between the outer aperture and the rim crest;
extending over the manifold base; and
cooperating with the manifold base and the rim to form the fluid manifold.

4. The tray assembly of claim 1:
wherein the tray base comprises a rim receptacle inset from the outer aperture and configured to locate around the build window;
wherein the rim:
is configured to transiently seat in the rim receptacle; and
defines the rim crest configured to offset the separation membrane above the build window by a first offset distance; and
further comprising a second rim:
configured to transiently seat in the rim receptacle in replacement of the rim;
defining a second inner aperture inset from the outer aperture and configured to locate around the build window; and
defining a second rim crest at a third vertical position above the first vertical position, circumscribing the inner aperture, and configured to offset the separation membrane above the build window by a second offset distance greater than the first offset distance.

5. The tray assembly of claim 1:
wherein the tray base comprises a rim receptacle inset from the outer aperture and configured to locate around the build window;
wherein the rim:
is configured to transiently seat in the rim receptacle; and
defines the rim crest configured to offset the separation membrane above the build window by a first offset distance; and
further comprising a shim configured to:
insert between the rim receptacle and the rim; and
raise the rim crest to a third vertical position above the first vertical position to offset the separation membrane above the build window by a second offset distance greater than the first offset distance.

6. The tray assembly of claim 1:
wherein the set of orifices are configured to:
pass fluid from the fluid manifold into the interstitial volume between the separation membrane and the build window during inflation of a center region of separation membrane above the build window; and
pass fluid from the interstitial volume into the fluid manifold during deflation of the center region of the separation membrane and lamination of the center region of the separation membrane across the build window; and
wherein the tray cap defines the reservoir:
comprising a reservoir floor at approximately the second vertical position of the rim crest; and
configured to supply resin toward the center region of the separation membrane during the build cycle.

7. The tray assembly of claim 6, wherein the tray cap further defines a
transition zone:
interposed between the reservoir and the outer aperture;
declined from the reservoir floor toward the outer aperture; and
configured to reduce hydraulic pumping of resin between the separation membrane and the tray cap during inflation and deflation of the separation membrane.

8. The tray assembly of claim 1:
wherein the tray base is configured to transiently install in the additive manufacturing system to locate a center region of the separation membrane over the build window; and
wherein the rim defines an undercut section:
arranged below the rim crest;
facing the build window;
intersecting the set of orifices; and
configured to prevent lamination of the center region of the separation membrane across the set of orifices.

9. The tray assembly of claim 8, wherein the separation membrane
comprises an intermediate annular region:
interposed between the center region and the rim crest; and cooperating with the undercut section of the rim to form a second fluid manifold:
encircling the build window; and
configured to distribute fluid, entering the set of orifices, about the build window to circumferentially delaminate the center region of the separation membrane from the build window.

10. The tray assembly of claim 1:
wherein the tray base comprises:
a set of retention features configured to constrain the separation membrane, proximal a perimeter of the separation membrane, to the tray base; and
a tension channel interposed between the set of retention features and the rim; and
wherein the tray cap comprises a tension element:
extending downwardly; and
configured to depress the separation membrane into the tension channel during assembly of the tray cap onto the tray base to tension the separation membrane across the rim.

11. The tray assembly of claim 10:
wherein the separation membrane comprises an array of perforations arranged proximal a periphery of the separation membrane; and
wherein the set of retention features of the tray base comprise a set of posts configured to:
insert into the array of perforations;
retain the separation membrane via the array of perforations; and
horizontally constrain a perimeter of the separation membrane.

12. The tray assembly of claim 10:
wherein the tension element:
is configured to transiently install in the tension channel;
defines a first height; and
is configured to depress the separation membrane into the tension channel by a first distance to tension the separation membrane to a first tension across the rim; and
further comprising a second tension element:
configured to transiently install in the tension channel in replacement of the tension element;
defining a second height greater than the first height; and
configured to depress the separation membrane into the tension channel by a second distance to tension the separation membrane to a second tension across the rim, the second tension greater than the first tension.

13. The tray assembly of claim 1:
wherein the separation membrane cooperates with the rim to form a second fluid manifold:
encircling the build window; and
configured to distribute fluid, entering the set of orifices, about the build window to circumferentially delaminate the center region of the separation membrane from the build window;
wherein the tray base further comprises a build window seal configured to:
seal against a support structure supporting the build window within the additive manufacturing system; and
prevent egress of fluid from the second fluid manifold past the tray base and the build window; and
wherein the tray base, the separation membrane, and the build window seal cooperate with the support structure and the build window of the additive manufacturing system to form a closed volume configured to receive fluid via the fluid port.

14. The tray assembly of claim 1, wherein the tray base further comprises a fluid channel:
fluidly coupled to the fluid port;
extending horizontally from the fluid port to a face of the tray base; and
configured to transiently couple to a flexible fluid supply line arranged in the additive manufacturing system above the build window.

15. A tray assembly comprising:
a separation membrane;
a tray cap:
arranged over a perimeter region of the separation membrane;
configured to seal against an upper surface of the separation membrane;
defining an outer aperture configured to locate around a build window of an additive manufacturing system; and
defining a reservoir;
arranged about the outer aperture; and
configured to cooperate with the separation membrane to store a resin; and
a tray base:
arranged below the separation membrane opposite the tray cap;
comprising a rim:
defining an inner aperture inset from the outer aperture and configured to locate around the build window; and
defining a rim crest circumscribing the inner aperture and configured to locate a center region of the separation membrane over the build window;
cooperating with an intermediate region of the separation membrane, between the perimeter region and the center region, to form a fluid manifold between the outer aperture and the rim;
defining a fluid port fluidly coupled to the fluid manifold;
defining a set of orifices:
extending laterally through the rim below the rim crest;
configured to pass fluid from the fluid manifold into an interstitial volume between the separation membrane and the build window during inflation of the separation membrane above the build window; and
configured to pass fluid from the interstitial volume into the fluid manifold during deflation of the separation membrane and lamination of the separation membrane across the build window; and
configured to transiently install in the additive manufacturing system adjacent the build window.

16. The tray assembly of claim 15, wherein the center region of the separation membrane:
is configured to:
laminate across the build window prior to irradiation of the resin, loaded from the reservoir into an interstice between the separation membrane and a preceding layer of a workpiece, by a projection system in the additive manufacturing system; and
pass electromagnetic radiation output by the projection system; and
is operable in:
a nominal position with the center region of the separation membrane approximating a planar surface at the second vertical position and offset above the build window;
a retracted position with the center region of the separation membrane laminated across the build window and with a second region of the separation membrane tensioned out of plane between the build window and the rim crest; and
an expanded position with the center region of the separation membrane inflated out of plane above the build window to peel the center region of the separation membrane from the build window.

17. The tray assembly of claim 15:
wherein the tray base comprises a rim receptacle inset from the outer aperture and configured to locate around the build window;
wherein the rim:
is configured to transiently seat in the rim receptacle; and
defines the rim crest configured to offset the center region of the separation membrane above the build window by a first offset distance; and
further comprising a second rim:
configured to transiently seat in the rim receptacle in replacement of the rim;
defining a second inner aperture inset from the outer aperture and configured to locate around the build window; and
defining a second rim crest at a third vertical position above the first vertical position, circumscribing the inner aperture, and configured to offset the center region of the separation membrane above the build window by a second offset distance greater than the first offset distance.

18. The tray assembly of claim 15:
wherein the tray base is configured to transiently install in the additive manufacturing system to locate a center region of the separation membrane over the build window; and
wherein the rim defines an undercut section:
arranged below the rim crest;
facing the build window;
intersecting the set of orifices; and
configured to prevent lamination of the center region of the separation membrane across the set of orifices.

19. A system comprising:
a tray assembly configured to transiently install in an additive manufacturing system and comprising:
a separation membrane;
a tray cap:
arranged over the separation membrane;
configured to seal against an upper surface of the separation membrane;
defining an outer aperture configured to locate around a build window of the additive manufacturing system; and
defining a reservoir;
arranged about the outer aperture; and
configured to cooperate with the separation membrane to store resin; and
a tray base:
arranged below the separation membrane opposite the tray cap; and
cooperating with the tray cap to tension the separation membrane across the outer aperture; and
a window clamp:
arranged about the build window in the additive manufacturing system;
comprising a rim:
defining an inner aperture inset from the outer aperture and configured to locate around the build window; and
defining a rim crest circumscribing the inner aperture and configured to locate the separation membrane above the build window;
cooperating with the separation membrane to form a fluid manifold:
extending between the outer aperture and the rim; and
arranged over a fluid port within the additive manufacturing system; and
defining a set of orifices:
extending laterally through the rim below the rim crest;
configured to pass fluid from the fluid manifold into an interstitial volume between the separation membrane and the build window during inflation of the separation membrane above the build window; and
configured to pass fluid from the interstitial volume into the fluid manifold during deflation of the separation membrane and lamination of the separation membrane across the build window.

20. The system of claim 18:
wherein the tray base is configured to locate a center region of the separation membrane over the build window; and
wherein the center region of the separation membrane:
is configured to:
laminate across the build window prior to irradiation of the resin, loaded from the reservoir into an interstice between the separation membrane and a preceding layer of a workpiece, by a projection system in the additive manufacturing system; and
pass electromagnetic radiation output by the projection system; and
is operable in:
a nominal position with the center region of the separation membrane approximating a planar surface at the second vertical position and offset above the build window;
a retracted position with the center region of the separation membrane laminated across the build window and with a second region of the separation membrane tensioned out of plane between the build window and the rim crest; and
an expanded position with the center region of the separation membrane inflated out of plane above the build window to peel the center region of the separation membrane from the build window.
